(19) United States
(12) Patent Application Publication
(10) Pub. No.: US 2010/0174729 A1
(43) Pub. Date: Jul. 8, 2010

(54) SYSTEM AND METHOD OF RECOLLECTION USING THE SEARCH OF RECORDS OF THE PAST

(76) Inventors: Hee Sook SHIN, Daejeon (KR); Ji Yeon SON, Daejeon (KR); Jun Seok PARK, Daejeon (KR); Chang Seok BAE, Daejeon (KR); JONGHO WON, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/394,222

(22) Filed: Feb. 27, 2009

Related U.S. Application Data
(60) Provisional application No. 61/142,667, filed on Jan. 6, 2009.

(51) Int. Cl. G06F 17/30; G06F 7/00

(52) U.S. Cl. 707/758; 707/E17.044; 707/E17.014; 707/E17.032; 707/E17.015

(57) ABSTRACT

A system of recollection using the search of records of the past, includes a database (DB) device storing records of individual's past events and things, a search computing device for making a search request in response to a user's request, a server computing device for searching the DB device in response to the search request to extract result data, and a presentation computing device for integrating and presenting the result data extracted from the server computing device by using multisensory elements.

### CROSS-REFERENCE(S) TO RELATED APPLICATION(S)

The present invention claims priority of U.S. Provisional Patent Application No. 61/142,667, filed on Jan. 6, 2009, which is incorporated herein by reference.

### FIELD OF THE INVENTION

The present invention relates to a system and method of recollection using the search of records of the past, which searches automatic or manual records of past events or things on a keyword or category basis and presents the results by various means, such as the senses of sight, hearing, touch, or smell in order to use them as the media for recollecting an individual's past.

This work was supported by the IT R&D program of MIC/IITA [2006-S-032-02, Development of an Intelligent Service Technology based on the Personal Life Log].

### BACKGROUND OF THE INVENTION

People tend to recollect their past more easily through media associated with past events and things, such as photos, music, smells, and so on. For example, things used in the past, music, data in various types of albums, or the like serve as media for recollecting specific memories of the past.

In recent years, since the present is recorded and managed as personal data through various digital devices, such as cameras and camcorders, or life logging devices, people can more easily get present digital records that will be the past.

With the recent development of technology, it is made easy to collect individual's record data. Thus, there is an ongoing study which applies the collected record data to a recollection method for enabling patients at the initial stage of Alzheimer's or aged people whose memory is falling to effectively recollect their past.

### SUMMARY OF THE INVENTION

It is an object of the present invention to provide a system and method of recollection using the search of records of the past which helps an individual to recollect their past by extracting required information by various searches from automatic or manual records of past events or things and presenting it through a sensory media.

In accordance with an aspect of the present invention, there is provided a system of recollection using the search of records of the past, including:

a database (DB) device storing automatic or manual records of individual's past events and things;

a search computing device for making a search request in response to a user's request;

a server computing device for searching the DB device in response to the search request from the search computing device to extract result data to the search request; and

a presentation computing device for integrating and presenting the result data extracted from the server computing device by using multisensory elements.

In accordance with another aspect of the present invention, there is provided a method of recollection using the search of records of the past, including:

building a database (DB) device of a person to therapy by collecting data of records of the past of the person;

requesting, at a search computing device, a server computing device to search for clues that can be used as media for helping the person subject to therapy to recollect his or her past;

searching for, at the server computing device, result data of records of the past that is to be used for recollecting the past by searching the DB device of the person subject to therapy in response to the search request;

providing, at the search computing device, the searched result data in the form of a list; and

providing, at the server computing device, data corresponding to a record of the past selected from the list to a presentation computing device for presenting the data.

### BRIEF DESCRIPTION OF THE DRAWINGS

The above and other objects and features of the present invention will become apparent from the following description of preferred embodiments, given in conjunction with the accompanying drawings, in which:

FIG. 1 illustrates a block diagram of a system of recollection using the search of records of the past in accordance with an exemplary embodiment of the present invention; and

FIG. 2 provides a flow chart showing a procedure of a recollection therapy application to which the present invention is applied.

### DETAILED DESCRIPTION OF THE EMBODIMENTS

Hereinafter, an exemplary embodiment of the present invention will be described in detail with reference to the accompanying drawings. The exemplary embodiment of the present invention describes a system and method of recollection which search automatic or manual records of past events or things on a keyword or category basis and presents the results by various means, such as the senses of sight, hearing, touch, or smell in order to use them as the media for recollecting the past of a person subject to therapy.

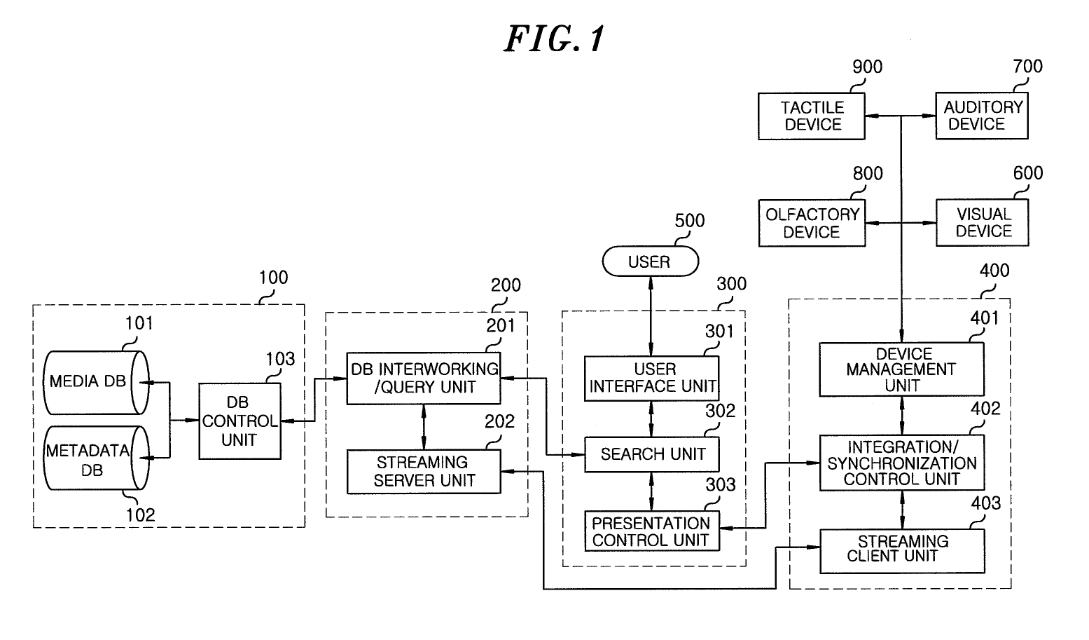

Referring now to FIG. 1, there is shown a block diagram of a system of recollection using the search of records of the past in accordance with an exemplary embodiment of the present invention. The inventive system includes a database (DB) device 100, a server computing device 200, a search computing device 300, and a presentation computing device 400.

The DB device 100 includes a media DB 101 that stores media data representing records of past events and things of an individual by the senses of sight, hearing, touch, and smell and a metadata DB 102 that stores information about individual records, elementary events and individual objects, for example, metadata such as names, meanings, representative words and so on. Each of the data stored in each of the DBs 101 and 102 contains values for variables corresponding to time, locations, characters, activities, and sensible information, and is classified to categorize for each variable and managed by a DB controller.

The server computing device 200 is composed of a DB interworking/query unit 201 and a streaming server unit 202. The DB interworking/query unit 201 receives a query request from the search computing device 300, searches required information from each of the DBs 101 and 102 in the DB device 100, and then provides searched records of the past to the search computing device 300. In some cases, a streaming service of the searched records of the past may be requested. In this case, the streaming server unit 202 plays the role of a streaming server, and the search computing device 300 or the presentation computing device 400 serves as a streaming client.

The search computing device 300 provides a user interface through which the user can search records of the past and supports various search methods. To this end, the search computing device 300 includes a user interface unit 301, a search unit 302, and a presentation controller 303. The user interface unit 301 enables a category-based search as well as a simple keyword-based search. Here, the categories are classified into time, locations, characters, activities, and sensible information. In some cases, the number of data contained in each category is provided to the user so that he or she can understand the distribution of data. In addition, the user interface unit 301 enables to perform a keyword search within the range of a category, and also supports a multiple keyword search, a multiple category search, and a cross search of the category search and the keyword search. The search unit 302 interworks the server computing device 200 to combine and deliver a search formula to the DB interworking/query unit 201, and provides the searched records of the past to the user interface unit 301 by which the searched records of the past are easily presented.

Further, the search computing device 300 provides a list of the searched records of the past which are in the form of representative words and representative images through the user interface unit 301 and the search unit 302, retrieves data corresponding to events or things regarding a specific record of the past selected from the list of the searched past records by the user 500, and transmits the retrieved data to the presentation computing device 400. The presentation controller 303 in the search computing device 300 provides control command for controlling the retrieved data to be presented through the presentation computing device. The control command includes command signals to start, pause, and stop the presentation of the retrieved data, command signals to individually select the reproduction of visual, auditory, tactile, and olfactory data, and command signals to individually select presentation intensities of the visual, auditory, tactile, and olfactory data.

The presentation computing device 400 is composed of a device management unit 401, an integration/synchronization control unit 402, and a streaming client unit 403. The streaming client unit 403 receives the retrieved data from the server computing device 200, and the integration/synchronization control unit 402 receives control command from the search computing device 300. Here, the retrieved data is data associated with the events or things regarding the specific search result selected by the user 500. The retrieved data includes media data representing the senses of sight, hearing, touch, and smell, and metadata about the integrated presentation and synchronization of the media data. Further, the presentation computing device 400 serves to as a streaming client, and the device management unit 401 performs the function of controlling and managing the operations of devices for multisensory presentation, for example, a visual device 600, an auditory device 700, an olfactory device 800, and a tactile device 900.

The DB device 100, the server computing device 200, the search computing device 300, and the presentation computing device 400 have a scheme to operate in conjunction with one another via wired and wireless networks for enabling data transmission and reception between them.

The system of the present invention so configured will be explained below based on an application scenario employing a recollection therapy for patients at the initial stage of Alzheimer's.

First, a database is built which records basic information about a patient subject to therapy and the past of the patient. As to the recording of the past, records of events or things taking place in everyday life are continuously collected by a logging device provided to the patient, or data is collected by using a separate logging device, such as a camera and camcorder, when a specific event takes place or the user wants to record. For aged people, data may be collected by getting records of the past from albums, photographs, or the like and converting them into digital data. As the collected data are of a raw data that is not refined, they are sorted in units of records of the past by using an automatic or manual editing tool and significant data of record of the past alone are extracted. Then, for a subsequent search or data utilization, metadata containing representative words, images, search-based category information are created from the past record data.

Through such a collection process of records of the past, the media DB 101 and the metadata DB 102 are prepared for the person subject to therapy, and the basic information about the person subject to therapy is also stored therein, thereby establishing the DB device 100.

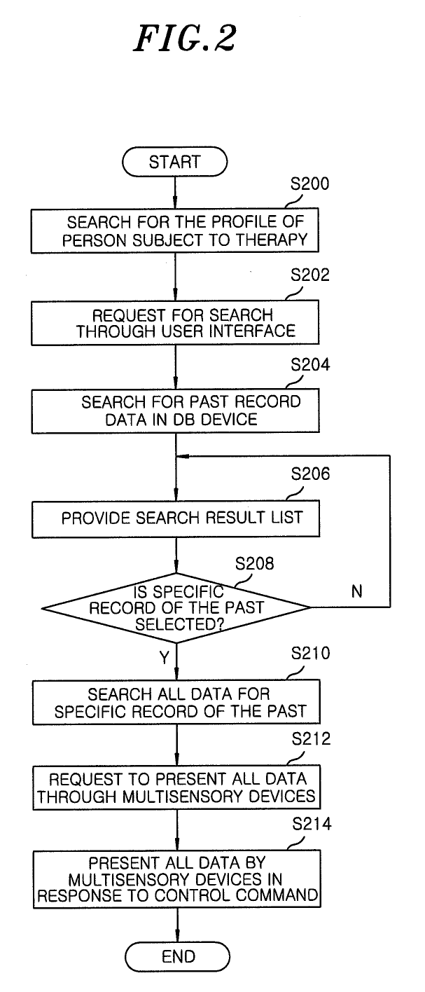

Upon completion of these processes, a recollection therapy is performed on the person subject to therapy, a procedure of which will be described below with reference to FIG. 2.

FIG. 2 provides a flow chart showing a procedure of a recollection therapy application to which the present invention is applied.

As shown in FIG. 2, in step S200, when there is a patient subject to therapy, e.g., an Alzheimer's patient, the user 500 playing the role of a therapist, makes a request to search for information about the patient (e.g., profile search of the patient). That is, the definition of data desired to be requested is given by the user interface unit 301 and the search unit 301 in the search computing device 300, and the user 500 and the DB device 100 interwork with each other through the DB interworking/query unit 201 and the DB control unit 103. Next, required data is collected by a combination of proper queries and then the result to the queries is provided to the user 500.

Here, in the recollection therapy application, the user interface unit 301 provides an interface and information for people who can assist with the recollection therapy, like family and therapists, rather than for the patient.

Thereafter, through the search computing device 300, the user 500 searches for clues that can be used as media for helping the person subject to therapy to recollect his or her past. This process provides a search method of records of the past, following category-based and keyword-based classifications through the user interface unit 301 of FIG. 1. By this search method, a search keyword is entered and a category is selected in step S202. The categories are composed of time, locations, characters, activities, and sensible information. For example, the user 500 can search in the activity category by using a keyword ‘wedding’ and search in the sensible information category by using keywords ‘snow’ and ‘cold’.

Next, in steps S204, the search unit 302 combines search keywords of the user 500 in a form suitable for query, and then transmits the same to the DB interworking/query unit 201. In response thereto, the DB interworking/query unit 201 searches for past record data of the patient in the DB device 100 through the DB control unit 103.

And then, in step S206, the search results, i.e., a list of records of the past, is provided to the search unit 302. At this time, the DB interworking/query unit 201 may perform a deduction and integration process of data by adding a recognition and AI (artificial intelligence) algorithm thereto, if necessary. Further, if there exist a plurality of persons subject to therapy, the DB device 100 may be implemented with separate devices as much. In this regard, the list of the search results is composed of representative images and representative words and is provided to the user 500 through the search computing device 300.

Subsequently, in step S208, when the user 500 selects one specific record of the past from the result list, the search unit 302 requests the server computing device 200 to search all data associated with selected record of the past.

Then, in step S210, the DB interworking/query unit 201 receives all of the data from the DB device 100 in response to the request to search all data associated with selected record of the past.

The server computing device 200 prepares to provide all the data provided from the DB device 100 to the client through the streaming server unit 202. Thereafter, in step S212, the user 500 makes a request to present the data of record of the past. The presentation control unit 303 then delivers the type of media to be controlled and control commands to the integration/synchronization control unit 402 of the presentation computing device 400, and receives the data of record of the past in a streaming fashion in conjunction with the streaming server unit 202 through the streaming client unit 403.

In step S214, the integration/synchronization control unit 402 controls the operations of the visual, auditory, tactile, and olfactory devices 600, 700, 800, and 900, which are multisensory devices, in response to control command from the presentation control unit 303 so as to achieve integrated presentation and synchronization of the past record data, and instructs the device management unit 401 to operate the multisensory devices individually. Accordingly, the device management unit 401 controls and operates the visual device 600, the auditory device 700, the tactile device 800, and the olfactory device 900 individually to represent the past record data.

Through this procedure, a clue serving as a medium of recollection is presented to a person subject to therapy, and the therapist repetitively performs this procedure partly to be consistent with the flow of therapy.

In accordance with the embodiment of the present invention, it is possible to retrieve automatic or manual records of past events or things on a keyword or category basis and present the results by various means, such as the senses of sight, hearing, touch, or smell in order to use them as the media for recollecting the past of a person subject to therapy. As a result, the present invention can achieve the effect of enhancing an individual's memory of the past by retrieving records of the past of the individual in various ways and reproducing the corresponding records similarly through a multisensory presentation device so as to play the role of a more effective medium.

Furthermore, the system of the present invention may be effectively used to remedy the symptom of an Alzheimer's patient by applying it to a recollection therapy.

While the invention has been shown and described with respect to the particular embodiments, it will be understood by those skilled in the art that various changes and modification may be made without departing from the scope of the invention as defined in the following claims.

What is claimed is:

1. A system of recollection using the search of records of the past, comprising:
a database (DB) device storing automatic or manual records of individual's past events and things;
a search computing device for making a search request in response to a user's request;
a server computing device for searching the DB device in response to the search request from the search computing device to extract result data to the search request; and
a presentation computing device for integrating and presenting the result data extracted from the server computing device by using multisensory elements.

2. The system of claim 1, wherein the DB device includes media data representing records of the individual's past events and things by the senses of sight, hearing, touch, or smell and metadata thereof, and each of the data contains values for variables corresponding to time, locations, characters, activities, and sensible information.

3. The system of claim 1, wherein the server computing device includes:
a DB interworking/query unit for converting and providing the result data in a format required by the search computing device, and performing the function of deducing and combining the result data; and
a streaming server unit for providing a streaming service of the result data to the presentation computing device upon request of the streaming service of the result data.

4. The system of claim 1, wherein the search computing device includes:
a user interface unit for providing an interface for a keyword-based or category-based search of records of the past of the individual; and
a presentation control unit for providing the presentation computing device with control command for controlling the result data provided to the presentation computing device.

5. The system of claim 4, wherein the presentation computing device includes:
a device management unit, connected to sensory devices, for controlling and operating the individual sensory devices;
a streaming client unit for receiving the result data extracted from the server computing device; and
an integration/synchronization control unit for controlling the operations of the individual sensory devices in response to the control command from the search computing device to thereby achieve integrated presentation and synchronization thereof.

6. A method of recollection using the search of records of the past comprising:
building a database (DB) device of a person to therapy by collecting data of records of the past of the person;
requesting, at a search computing device, a server computing device to search for clues that can be used as media for helping the person subject to therapy to recollect his or her past;
searching for, at the server computing device, result data of records of the past that is to be used for recollecting the past by searching the DB device of the person subject to therapy in response to the search request;
providing, at the search computing device, the searched result data in the form of a list; and
providing, at the server computing device, data corresponding to a record of the past selected from the list to a presentation computing device for presenting the data.

7. The method of claim 6, wherein, in said requesting, at a search computing device, a server computing device to search for clues, the search computing device requests the server computing device to search on a keyword basis and on the basis of categories of time, locations, characters, activities, and sensible information.

8. The method of claim 6, further comprising:
providing, at the search computing device, control command for controlling a presentation method of the data corresponding to the record of the past to the presentation computing device; and
presenting, at the presentation computing device, the data corresponding to the record of the past by controlling the operations of the sensory devices that operate in conjunction with the presentation computing device in response to the control data.

9. The method of claim 8, wherein the control command includes control signals to start, pause, and stop the presentation of the data corresponding to the record of the past and control signals to present sensory data and to control present intensities of the sensory data.

10. The method of claim 9, wherein the data corresponding to the record of the past is presented by multisensory integration by synchronizing visual, auditory, tactile, and olfactory presentation devices to present the sensory data.

11. The method of claim 6, wherein the searched result data corresponding to the record of the past includes a representative image and a representative word.
